(19) United States
(12) Patent Application Publication
(10) Pub. No.: US 2007/0101647 A1
(43) Pub. Date: May 10, 2007

(54) Hydrogen generating apparatus, method of operating hydrogen generating apparatus, fuel cell system, and method of operating fuel cell system

(75) Inventors: Shinji Miyauchi, Nara (JP); Terumaru Harada, Nara (JP); Kunihiro Ukai, Nara (JP); Kiyoshi Taguchi, Osaka (JP); Seiji Fujihara, Hyogo (JP); Tetsuya Ueda, Aichi (JP)

Correspondence Address: STEVENS, DAVIS, MILLER & MOSHER, LLP, 1615 L. STREET N.W., SUITE 850, WASHINGTON, DC, 20036, US

(73) Assignee: MATSUSHITA ELECTRIC INDUSTRIAL CO., LTD., Osaka (JP)

(21) Appl. No.: 10/579,748

(22) PCT Filed: Jan. 14, 2005
(86) PCT No.: PCT/JP05/00397

§ 371 Date: May 18, 2006

(30) Foreign Application Priority Data
Jan. 15, 2004 (JP) 2004-007605
Aug. 3, 2004 (JP) 2004-226485

(51) Int. Cl. C01B 3/32

(52) U.S. Cl. 48/198.7; 48/127.9

(57) ABSTRACT

A hydrogen generating apparatus or the like is able to detect an excess water state or an excess steam state in the interior of a shift converter or a selective oxidation device. The hydrogen generating apparatus (120) comprise a hydrogen generator (118) including a reformer (100) configured to generate a reformed gas from a material and steam; a shift converter (103) configured to cause the reformed gas supplied from the reformer (100) to be subjected to a shift reaction; and a selective oxidation device (105) configured to decrease a concentration of carbon monoxide in the reformed gas after the shift reaction to a predetermined concentration or less; a temperature sensor (116, 117) configured to detect one of a temperature of the shift converter (103) and a temperature of the selective oxidation device (105); and a controller (205) configured to determine that excess water or excess steam exists in an interior of the hydrogen generator (118) when an increasing rate of the temperature detected by the temperature sensor is less than a predetermined threshold.

### TECHNICAL FIELD

The present invention relates to a hydrogen generating apparatus, a method of operating the hydrogen generating apparatus, a fuel cell system, and a method of operating the fuel cell system (hereinafter referred to as a hydrogen generating apparatus or the like). More particularly, the present invention relates to a hydrogen generating apparatus or the like which is capable of detecting an excess water state or an excess steam state in the interior(s) of a shift converter and/or a selective oxidation device for decreasing carbon monoxide in a reformed gas.

### BACKGROUND ART

Fuel cell systems are configured to cause a hydrogen-rich reformed gas supplied as a fuel gas to an anode of a fuel cell and air or the like supplied as an oxidizing gas to a cathode of the fuel cell to electrochemically react with each other in the interior of the fuel cell, to thereby generate electric power and heat. One method of generating the hydrogen-rich reformed gas is a steam reforming method. In this method, a material such as a natural gas, a hydrocarbon based gas such as LPG, alcohol such as methanol, or gasoline such as naphtha, and steam are caused to react with each other to generate the hydrogen-rich reformed gas. A hydrogen generating apparatus that generates the reformed gas generally contains a reformer for a steam reforming reaction, a shift converter for a shift reaction, and a selective oxidation device for CO selective oxidation. These components are provided with a reforming catalyst body, a shift reaction catalyst body, and a CO selective oxidation catalyst body, respectively.

Correct reaction temperatures of these catalyst bodies are different from each other. Therefore, in order to allow hydrogen to be supplied stably and efficiently, it is necessary to quickly increase the temperatures of the respective catalyst bodies up to the correct temperatures and keep them at the correct temperatures after start-up of the hydrogen generating apparatus.

It has been pointed out that, when the steam is supplied excessively to the hydrogen generating apparatus, water condensation may occur, causing hindrance to an increase or stability of the reaction temperature.

In order to solve this problem, there has been disclosed a hydrogen generating apparatus that employs a method in which a shift reaction catalyst body contained in a shift converter is heated by a shift converter heater to increase a temperature of a reformed gas supplied from a reformer to the shift converter through a gas passage up to a dew point or higher (see patent document 1). This makes it possible to reduce time required to supply hydrogen stably at the start-up of the hydrogen generating apparatus and to inhibit degradation of activity of a shift converter catalyst which may be caused by water condensation.

Patent Document 1: Japanese Laid-Open Patent Application Publication No. 2001-354404 (FIG. 1)

### DISCLOSURE OF THE INVENTION

### Problems to be Solved by the Invention

The patent document 1 fails to disclose a method to detect an excess water state or an excess steam state in the interior of the shift converter or the selective oxidation device. For this reason, the hydrogen generating apparatus of the patent document 1 is incapable of addressing, at correct timings, reduction of a loss of start-up energy in the fuel cell system or reduction of activity of the catalyst in the interior(s) of the shift converter and/or the selective oxidation device. That is, how to surely detect the excess water state or the excess steam state in the interior(s) of the shift converter or the selective oxidation device has not been made clear yet.

More specifically, in the hydrogen generating apparatus of the patent document 1, it is difficult to surely detect the event that water for steam reforming is supplied excessively to the reformer, water for causing shift reaction between water and carbon monoxide is supplied excessively to the shift converter, or excess steam or excess condensed water remains in the interior(s) of the reformer, the shift converter, or the selective oxidation device, which may be caused by repeated heating and cooling of the hydrogen generating apparatus due to frequent of start-up and stop of the hydrogen generating apparatus. This may cause the reforming catalyst body, the shift reaction catalyst body or the CO selective oxidation catalyst body to be immersed in excess water for a long time period. As a result, activity of these catalysts may degrade.

If the fuel cell system continues to start-up and generate power with the activity of the shift converter catalyst and the activity of the CO selective oxidation catalyst body degraded, carbon monoxide is not fully removed from the reformed gas in the interiors of the shift converter and the selective oxidation device, causing the catalysts of the fuel cell to be poisoned by the remaining carbon monoxide. As a result, the fuel cell may decrease its output power and, further, abnormal stop of the fuel cell system may arise.

The present invention has been made to solve the above mentioned problem, and an object of the present invention is to provide a hydrogen generating apparatus or the like which is capable of detecting an excess water state or an excess steam state in the interior of a shift converter or a selective oxidation device by a simple method.

Another object of the present invention is to provide a hydrogen generating apparatus or the like which is capable of correctly removing excess water or excess steam from the interior of the shift converter or the selective oxidation device to thereby reduce a loss of start-up energy of the hydrogen generating apparatus and to thereby inhibit degradation of catalytic activity of the shift converter and/or the selective oxidation device.

### MEANS FOR SOLVING THE PROBLEM

In order to solve the above mentioned problems, a hydrogen generating apparatus of the present invention comprises a hydrogen generator including a reformer configured to generate a reformed gas from a material and steam; a shift converter configured to cause the reformed gas supplied from the reformer to be subjected to a shift reaction; and a selective oxidation device configured to decrease a concentration of carbon monoxide in the reformed gas after the shift reaction; a temperature sensor configured to detect one of a temperature of the shift converter and a temperature of the selective oxidation device; and a controller configured to determine that excess water or excess steam exists in an interior of the hydrogen generator when an increasing rate of the temperature detected by the temperature sensor is less than a predetermined threshold.

The controller may determine that excess water or excess steam exists in an interior of a shift converter when an increasing rate of the temperature of the shift converter that is detected by the temperature sensor is less than a predetermined threshold. In addition, the controller may determine that excess water or excess steam exists in an interior of the selective oxidation device when an increasing rate of the temperature of the selective oxidation device that is detected by the temperature sensor is less than a predetermined threshold.

Thereby, it is possible to accurately detect the excess water state or the excess steam state in the interior(s) of the shift converter and/or the selective oxidation device, and to address the excess state quickly by an operation of the hydrogen generating apparatus described below. As a result, a loss of a start-up energy of the hydrogen generating apparatus is reduced, and degradation of catalytic activity of the shift converter and/or the selective oxidation device is avoided.

A hydrogen generating apparatus of the present invention comprises a hydrogen generator including a reformer configured to generate a reformed gas from a material and steam; a shift converter configured to cause the reformed gas supplied from the reformer to be subjected to a shift reaction; and a selective oxidation device configured to decrease a concentration of carbon monoxide in the reformed gas after the shift reaction to a predetermined concentration or less; a temperature sensor configured to detect one of a temperature of the shift converter and a temperature of the selective oxidation device; and a controller configured to perform control to decrease water or steam in an interior of the hydrogen generator when an increasing rate of the temperature detected by the temperature sensor is less than a predetermined threshold.

In one example, the hydrogen generating apparatus configured to be controlled to decrease the water or the steam may further comprise a water supply device configured to supply the water or the steam to the hydrogen generator, and the controller may be configured to control the water supply device to decrease an amount of the water or the steam supplied to the interior of the hydrogen generator when the increasing rate of the temperature detected by the temperature sensor is less than the predetermined threshold.

In another example, the hydrogen generating apparatus configured to be controlled to decrease the water or the steam further comprise a water discharge device that is equipped in the shift converter and is configured to discharge the water; and the controller may be configured to control the water discharge device to discharge the water from an interior of the shift converter to outside when an increasing rate of a temperature of the shift converter that is detected by the temperature sensor is less than a predetermined threshold. Or, the hydrogen generating apparatus may further comprise a water discharge device that is equipped in the selective oxidation device and is configured to discharge the water; and the controller may be configured to control the water discharge device to discharge the water from an interior of the selective oxidation device to outside when an increasing rate of a temperature of the selective oxidation device that is detected by the temperature sensor is less than a predetermined threshold.

In a further example, the hydrogen generating apparatus configured to be controlled to decrease the water or the steam may further comprise an air supply device configured to supply air to the shift converter; and the controller may be configured to control the air supply device to introduce the air to an interior of the shift converter when an increasing rate of the temperature of the shift converter that is detected by the temperature sensor is less than a predetermined threshold. Or, the hydrogen generating apparatus may further comprise an air supply device configured to supply air to the selective oxidation device; and the controller may be configured to control the air supply device to introduce the air to the interior of the selective oxidation device when an increasing rate of the temperature of the selective oxidation device that is detected by the temperature sensor is less than a predetermined threshold.

In a further example, the hydrogen generating apparatus configured to be controlled to decrease the water or the steam may further comprise a heating device configured to heat the shift converter; and the controller may be configured to control the heating device to heat an interior of the shift converter when an increasing rate of the temperature of the shift converter that is detected by the temperature sensor is less than a predetermined threshold. Or, the hydrogen generating apparatus may further comprise a heating device configured to heat the selective oxidation device; and the controller may be configured to control the heating device to heat an interior of the selective oxidation device when an increasing rate of the temperature of the selective oxidation device that is detected by the temperature sensor is less than a predetermined threshold.

The water discharge device, the air supply device or the heater enables the excess water resulting from the steam or the condensed moisture to be correctly removed from the shift converter and/or the selective oxidation device.

A method of operating a hydrogen generating apparatus comprising a hydrogen generator including a reformer configured to generate a reformed gas from a material and steam; a shift converter configured to cause the reformed gas supplied from the reformer to be subjected to a shift reaction; and a selective oxidation device configured to decrease a concentration of carbon monoxide in the reformed gas after the shift reaction to a predetermined concentration or less; and a temperature sensor configured to detect one of a temperature of the shift converter and a temperature of the selective oxidation device, the method comprising: decreasing water or steam in an interior of the hydrogen generator when an increasing rate of the temperature detected by the temperature sensor is less than a predetermined threshold.

Or, a method of operating a fuel cell system comprising a hydrogen generator including a reformer configured to generate a reformed gas from a material and steam; a shift converter configured to cause the reformed gas supplied from the reformer to be subjected to a shift reaction; and a selective oxidation device configured to decrease a concentration of carbon monoxide in the reformed gas after the shift reaction to a predetermined concentration or less; a fuel cell configured to generate electric power using the reformed gas supplied from the reformer and an oxidizing gas; and a temperature sensor configured to detect one of a temperature of the shift converter and a temperature of the selective oxidation device, the method comprising: decreasing water or steam in an interior of the hydrogen generator when an increasing rate of the temperature detected by the temperature sensor is less than a predetermined threshold.

A hydrogen generating apparatus of the present invention comprises a hydrogen generator including a reformer configured to generate a reformed gas supplied from a material and steam; a shift converter configured to cause the reformed gas supplied from the reformer to be subjected to a shift reaction; a selective oxidation device configured to decrease a concentration of carbon monoxide in the reformed gas after the shift reaction to a predetermined concentration or less; a reformer heater configured to heat the reformer; a combustion sensor configured to detect a combustion state of a combustible gas in the reformer heater; and a controller configured to determine that excess water or steam exists in an interior of the hydrogen generator when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

Thereby, it is possible to accurately detect the excess water state or the excess steam state in the interior of the shift converter or the selective oxidation device, and to address the excess state quickly by an operation of the hydrogen generating apparatus described below. As a result, a loss of a start-up energy of the hydrogen generating apparatus is reduced, and degradation of catalytic activity of the shift converter and/or the selective oxidation device is avoided.

A hydrogen generating apparatus of the present invention comprises a hydrogen generator including a reformer configured to generate a reformed gas from a material and steam; a shift converter configured to cause the reformed gas supplied from the reformer to be subjected to a shift reaction; a selective oxidation device configured to decrease a concentration of carbon monoxide in the reformed gas after the shift reaction to a predetermined concentration or less; a reformer heater configured to heat the reformer; a combustion sensor configured to detect a combustion state in the reformer heater; and a controller configured to perform control to decrease water or steam in an interior of the hydrogen generator when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

In one example, the hydrogen generating apparatus configured to be controlled to decrease the water or the steam may further comprise a water supply device configured to supply the water or the steam to the hydrogen generator, and the controller may be configured to control the water supply device to decrease an amount of the water or the steam supplied to the interior of the hydrogen generator when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

In another example, the hydrogen generating apparatus configured to be controlled to decrease the water or the steam may further a water discharge device that is equipped in the shift converter and/or the selective oxidation device and is configured to discharge water; and the controller may be configured to control the water discharge device to discharge water from an interior of the shift converter and/or an interior of the selective oxidation device to outside when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

In another example, the hydrogen generating apparatus configured to be controlled to decrease the water or the steam may further an air supply device configured to supply air to the shift converter and/or the selective oxidation device; and the controller may be configured to control the air supply device to introduce air to an interior of the shift converter and/or an interior of the selective oxidation device when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

In a further example, the hydrogen generating apparatus configured to be controlled to decrease the water or the steam may further comprise a heating device configured to heat the shift converter and/or the selective oxidation device; and the controller may be configured to control the heating device to heat an interior of the shift converter and/or the selective oxidation device when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

The water discharge device, the air supply device or the heating device enables the excess water resulting from the steam or the condensed moisture to be correctly removed from the shift converter and/or the selective oxidation device.

A fuel cell system of the present invention comprises the above described hydrogen generating apparatus; and a fuel cell configured to generate electric power using a reformed gas supplied from the hydrogen generator and an oxidizing gas. And, a method of operating a hydrogen generating apparatus comprising a hydrogen generator including a reformer configured to generate a reformed gas from a material and steam; a shift converter configured to cause the reformed gas supplied from the reformer to be subjected to a shift reaction; a selective oxidation device configured to decrease a concentration of carbon monoxide in the reformed gas after the shift reaction to a predetermined concentration or less; a reformer heater configured to heat the reformer; and a combustion sensor configured to detect a combustion state of a combustible gas in the reformer heater; the method comprising: decreasing water or steam in an interior of the hydrogen generator when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

Also, a method of operating a fuel cell system comprising a hydrogen generator including a reformer configured to generate a reformed gas from a material and steam; a shift converter configured to cause the reformed gas supplied from the reformer to be subjected to a shift reaction; a selective oxidation device configured to decrease a concentration of carbon monoxide in the reformed gas after the shift reaction to a predetermined concentration or less; a reformer heater configured to heat the reformer; a fuel cell configured to generate electric power using a reformed gas supplied from the hydrogen generator and an oxidizing gas, and a combustion sensor configured to detect a combustion state of a combustible gas in the reformer heater, the method comprising: decreasing water or steam in an interior of the hydrogen generator when a detection signal detected by the combustion sensor reaches, with a frequency of predetermined number of times or more, a numeric value at which a flame vanishes in the reformer heater, during a time period that elapses from when a temperature of the shift converter reaches a shift reaction temperature range until a temperature of the selective oxidation device reaches a selective oxidation reaction temperature range.

### EFFECTS OF THE INVENTION

In accordance with the present invention, it is possible to achieve a hydrogen generating apparatus or the like that is capable of detecting an excess water state or an excess steam state in the interior of a shift converter or a selective oxidation device.

In addition, in accordance with the present invention, it is possible to provide a hydrogen generating apparatus or the like which is capable of correctly removing excess water or excess steam from the interior of the shift converter or the selective oxidation device to thereby reduce a loss of start-up energy of the hydrogen generator and to thereby inhibit degradation of catalytic activity of the shift converter and/or the selective oxidation device.

### BRIEF DESCRIPTION OF THE DRAWINGS

FIG. 1 is a block diagram showing a construction of a fuel cell system according to an embodiment 1 of the present invention;

FIG. 2 is a view showing rising temperature characteristics of a reformer, a shift converter, and a selective oxidation device of a hydrogen generator from start-up of the hydrogen generator, under the condition in which steam is supplied normally and excessively;

FIG. 3 is a block diagram showing a construction of a fuel cell system according to an embodiment 2 of the present invention;

FIG. 4 is a view showing an example of correlation in a normal state between time (start-up time) on an abscissa axis and a detected reformer temperature (KS), a detected combustion temperature (TFG), and a detected combustion flame current (FRG) on a ordinate axis, in which the start-up time represents a time period that elapses from when the hydrogen generator starts start-up operation (to), the detected reformer temperature (KS) is output from a reformer temperature sensor, the detected combustion temperature (TFG) is output from a temperature detecting means used as a combustion sensor, and the detected combustion flame current (FRG) is output from a flame current detecting means used as the combustion sensor;

FIG. 5 is a view showing an example of correlation in an abnormal state between time (start-up time) on an abscissa axis and a detected reformer temperature (KSN), a detected combustion temperature (TFN), and a detected combustion flame current (FRN) on a ordinate axis, in which the start-up time represents a time period that elapses from when the hydrogen generator starts start-up operation (to), the detected reformer temperature (KSN) is output from the reformer temperature sensor, the detected combustion temperature (TFN) is output from the temperature sensor used as the combustion sensor, and the detected combustion flame current (FRN) is output from the flame current sensor used as the combustion sensor;

FIG. 6 is a flowchart showing an example of a control program of a controller at the start-up of the hydrogen generator;

FIG. 7 is a block diagram showing a construction of a fuel cell system according to an embodiment 3 of the present invention;

FIG. 8 is a block diagram showing a construction of a fuel cell system according to an embodiment 4 of the present invention; and

FIG. 9 is a block diagram showing a construction of a fuel cell system according to an embodiment 5 of the present invention.

### EXPLANATION OF REFERENCE NUMERALS

100 reformer
101 reforming catalyst body
102 reformer heater
103 shift converter
104 shift reaction catalyst body
105 selective oxidation device
106 CO selective oxidation catalyst body
107 material feed means
108 first water supply device
109 second water supply device
110, 206 electromagnetic valve
111 combustion fan
113 shift converter heater
114 selective oxidation device heater
115 reformer temperature sensor
116 shift converter temperature sensor
117 selective oxidation device temperature sensor
118 hydrogen generator
120 hydrogen generating apparatus
200 oxidizing gas supply means
201 air supply device
202 oxidizing gas humidifier
203 fuel cell
204 switching valve
300 fuel cell system
301 first fuel gas passage
302 second fuel gas passage
303 first reformed gas passage
304 second reformed gas passage
305 third reformed gas passage
306 first branch passage
307 second branch passage
308 first water passage
309 second water passage
310 third water passage
311 first air passage
312 second air passage
400, 401 discharge valve
402, 403 discharge passage
500, 501 air supply pump
502, 503 dry air supply passage
600, 601 exhaust gas supply valve
602, 603 exhaust gas supply passage

### BEST MODE FOR CARRYING OUT THE INVENTION

Hereinafter, embodiments 1 to 5 of the present invention will be described with reference to the drawings.

### Embodiment 1

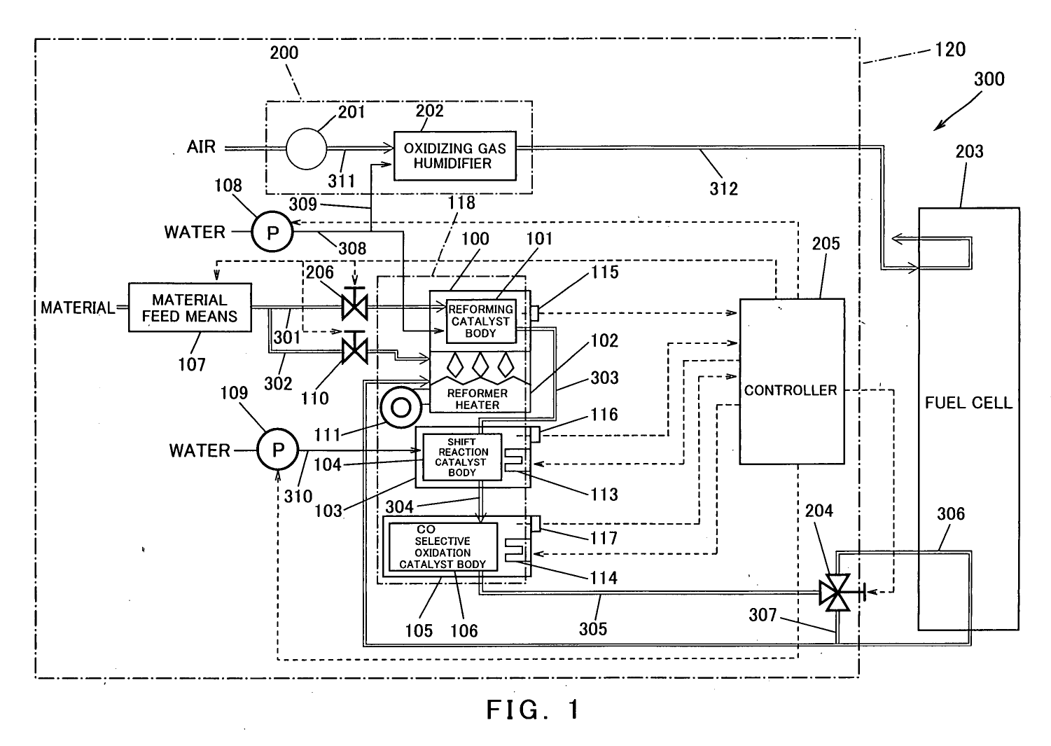

FIG. 1 is a block diagram showing a construction of a fuel cell system according to an embodiment 1 of the present invention.

A hydrogen generating apparatus 120 mainly comprises a hydrogen generator 118 configured to supply a hydrogen-rich gas to a fuel cell 203, a controller 205 that is configured to control a feed amount of a hydrocarbon based material such as methane, butane, and a natural gas and to detect the temperature(s) of a shift converter 103 and/or a selective oxidation device 105 of the hydrogen generator 118 to detect and determine whether or not the amount of water or the amount of steam is correct; an oxidizing gas supply means 200 configured to supply air which is the oxidizing gas to the fuel cell 203, a material feed means 107 configured to feed the material to the hydrogen generator 118, and first and second water supply devices 108 and 109 configured to supply water to the hydrogen generator 118.

A fuel cell system 300 comprises the above mentioned hydrogen generating apparatus 120 and the fuel cell 203 configured to generate electric power using the hydrogen-rich gas supplied from the hydrogen generating apparatus 120.

The hydrogen generator 118 includes the reformer 100 configured to conduct a steam reforming reaction, the shift converter 103 configured to conduct a shift reaction to convert steam and carbon monoxide into hydrogen and carbon dioxide, and the selective oxidation device 105 configured to conduct CO selective oxidation to decrease a concentration of carbon monoxide to approximately 10 ppm or lower. The reformer 100 is provided with a reforming catalyst body 101 that promotes the steam reforming reaction and a reformer heater 102 that supplies heat for reforming reaction to the reforming catalyst body 101. The shift converter 103 is provided with a shift reaction catalyst body 104 and a shift converter heater 113 that heats the shift reaction catalyst body 104. The selective oxidation device 105 is provided with a CO selective oxidation catalyst body 106 and a selective oxidation device heater 114 that heats the CO selective oxidation catalyst body 106. The heaters 113 and 114 heat the shift converter 103 and the selective oxidation device 105, respectively, to reduce a time period necessary to increase the temperature at the start-up the hydrogen generator 118.

The oxidizing gas supply means 200 includes an air supply device 201 such as a blower fan and an oxidizing gas humidifier 202 that humidifies air.

[Detailed Construction of Hardware of Fuel Cell System]

A detailed construction of hardware of the fuel cell system 300 will be described with reference to FIG. 1. In the fuel cell 203, power generation is carried out in such a manner that the hydrogen-rich gas (hereinafter referred to as a reformed gas) introduced to an anode (not shown) and the air introduced to a cathode (not shown) react with each other to generate electric power and heat.

First, passages through which the reformed gas is introduced to the anode and the associated gas reaction will be described. The material comprising an organic compound containing at least carbon and hydrogen is controlled to have a correct flow rate by an electromagnetic valve 206 that is provided in a first fuel gas passage 301 to open and close the first fuel gas passage 301 and a material flow rate control valve (not shown) within the material feed means 107, and then is guided to the reforming catalyst body 101. Simultaneously, the water or the steam is supplied from the first water supply device 108 to the reforming catalyst body 101 through a first water passage 308. Thereby, in the reformer 100, the reforming catalyst body 101 causes the steam reforming reaction to proceed, thereby generating the hydrogen-rich reformed gas from the material and the steam.

A second fuel gas passage 302 branches from the first fuel gas passage 301. An electromagnetic valve 110 is provided in the second fuel gas passage 302. The material, the flow rate of which has been controlled by the electromagnetic valve 110 and the material flow rate control valve, is fed as a combustion material to a burner of the reformer heater 102 through the passage 302. A combustion fan 111 supplies combustion air to the burner of the reformer heater 102.

The reformed gas is guided from the reforming catalyst body 101 to the shift reaction catalyst body 104 through a first reformed gas passage 303, while water is supplied from the second water supply device 109 to the shift reaction catalyst body 104 through a third water passage 310. This causes the shift reaction to convert carbon monoxide in the reformed gas and the steam into hydrogen and carbon dioxide. In order to decrease the concentration of carbon monoxide in the gas resulting from the shift reaction to a predetermined concentration level (e.g., 10 ppm or less), the reformed gas after the shift reaction is guided to the CO selective oxidation catalyst body 106 through a second reformed gas passage 304 to further decrease the concentration of CO through CO selective oxidation. In this manner, the reformed gas containing hydrogen as a major component, the CO concentration of which has been decreased, is generated in the hydrogen generator 118.

Then, the reformed gas containing hydrogen as a major component flows from the selective oxidation device 105 of the hydrogen generator 118 into a third reformed gas passage 305. Then, a switching valve 204 provided in the third reformed gas passage 305 causes the hydrogen-rich gas to flow in a first or second branch passage 306 or 307 to allow the hydrogen-rich gas to be supplied to the fuel cell 203 or to the reformer heater 102 through the passage 306 or 307, respectively. A part of the reformed gas is guided to the anode of the fuel cell 203 through the first passage 306 and is consumed in required amount through an electrode reaction of the anode, and then, the remaining reformed gas is caused to flow to the burner of the reformer heater 102, as an off gas. Through the second passage 307, the reformed gas is caused to flow to the burner of the reformer 102 without being guided to the anode.

The reformed gas that has flowed to the burner of the reformer heater 102 is combusted with air supplied from the combustion fan 111 in the interior of the reformer heater 102.

Subsequently, passages through which air is guided to the cathode will be described. The air is supplied from the air supply device 201 to the oxidizing gas humidifier 202 through a first air passage 311. The water is supplied from the first water supply device 108 to the oxidizing gas humidifier 202 through a second water passage 309 that branches from a first water passage 308. In the oxidizing gas humidifier 202, air is humidified and is guided to the cathode of the fuel cell 203 through a second air passage 312. The humidified air which has not been consumed in the cathode of the fuel cell 203 is released to atmosphere.

[Configuration of Control System of Fuel Cell System]

Subsequently, a configuration of a control system of the fuel cell system 300 will be described with reference to FIG. 1.

The controller 205 includes an arithmetic unit such as a microcomputer, and is configured to control desired components of the fuel cell system 300 to thereby control the operation of the fuel cell system 300.

As used herein, the term “controller” refers to a controller group in which a plurality of controllers cooperate with each other to control the operation of the fuel cell system 300, as well as a single controller. Therefore, the controller 205 is not necessarily constituted by the single controller, but may be a plurality of controllers that are distributed and cooperate with each other to control the operation of the fuel cell system 300.

Input sensors of the controller 205 include various types of temperature sensors. To be specific, the temperature sensors include a reformer temperature sensor 115 that detects a temperature of a gas in the reformer 100 (temperature of the gas near the reforming catalyst body 101), a shift converter temperature sensor 116 that detects a temperature of a gas in the shift converter 103 (temperature of the gas near the shift reaction catalyst body 104), and a selective oxidation device sensor 117 that detects a temperature of a gas in the selective oxidation device 105 (temperature of the gas near the CO selective oxidation catalyst body 106).

The reformer temperature sensor 115 is attached on the reformer 100 to detect the temperature of the gas on upstream side of the reforming catalyst body 101. The shift converter temperature sensor 116 is attached on the shift converter 100 to detect the temperature on upstream side of the shift reaction catalyst body 104. The selective oxidation device temperature sensor 117 is attached on the selective oxidation device 100 to detect the temperature on upstream side of the CO selective oxidation catalyst body 105.

Excess steam condenses to water, which stays at a lower end region of a tubular catalyst body (on downstream side in the flow of the gas). For this reason, catalyst may be exposed to severer environment at the lower end region on downstream side than at an upper end region on upstream side in flow of the gas. Therefore, if it is detected by the temperature sensor disposed on the upstream side of the catalyst that an abnormality due to excess water occurs on the upstream side, then it is definitely determined that the downstream region of the catalyst is exposed to excess water.

An output operation portion controlled by the controller 205 includes the flow rate control portion of the first and second water supply devices 108 and 109, the electromagnetic valve 206 that controls the amount of material fed to the reforming catalyst body 101, the electromagnetic valve 110 that controls the combustion material fed to the burner of reformer heater 102, the material flow rate control valve that is built into the material feed means 107 to control the amount of material fed from a source, the shift converter heater 113 that heats the shift converter 103, the selective oxidation device heater 114 that heats the selective oxidation device 105, the switching valve 204 that switches the passage of the reformed gas supplied from the hydrogen generator 118, etc.

The controller 205 receives the temperatures which have been detected by the temperature sensors 115, 116, and 117. Based on these temperatures, the controller 205 causes the flow rate control valve built into the material feed means 107 and the electromagnetic valves 110 and 206 to operate to stabilize the reaction temperatures of the respective catalyst bodies 101, 104, and 106, and controls the output of the shift converter heater 113 and the output of the selective oxidation device heater 114 to reduce the time required to increase the temperature of the shift converter 103 and the temperature of the selective oxidation device 105 at the start-up of the hydrogen generator 118. Further, the controller 205 causes the switching valve 204 to operate so that generated gas (reformed gas) supplied from the hydrogen generator 118 is selectively guided to the fuel cell 203 or to the reformer heater 102.

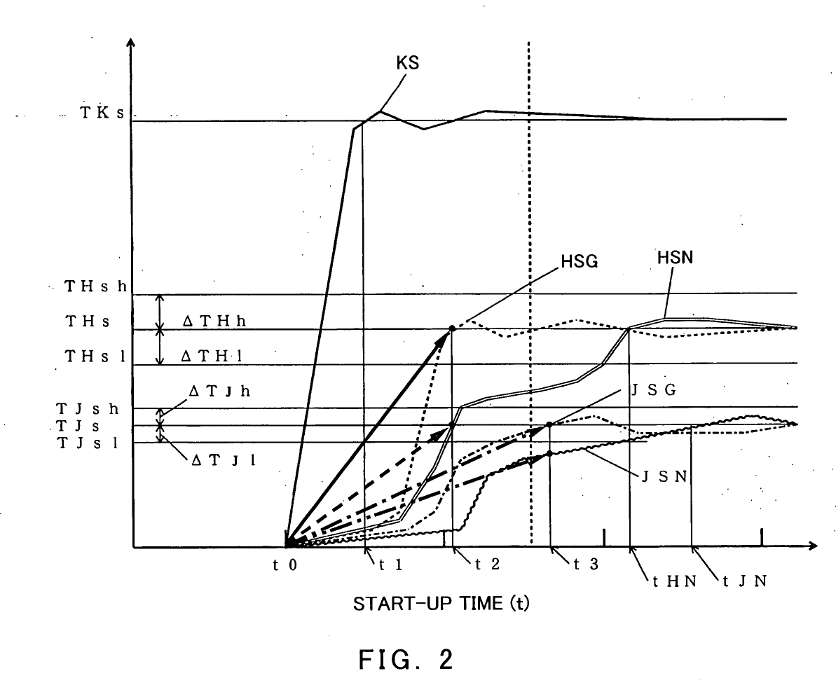

FIG. 2 shows rising temperature characteristics of the reformer 100, the shift converter 103, and the selective oxidation device 105, in which an abscissa axis indicates a time that elapses from when the hydrogen generator 118 starts the start-up operation (time point at which the reformer heater 102 starts heating the reforming catalyst body 101: to).

In FIG. 2, KS profile, HSG profile, and JSG profile represent the rising characteristics of detected temperatures of the reformer 100, the shift converter 103, and the selective oxidation device 105 in a case where the steam used for the steam reforming reaction is correctly supplied to the reformer 100 of the hydrogen generator 118 and the steam for stably controlling the temperature of the shift converter 103 is correctly supplied to the shift converter 103.

Since set values in the reaction temperature ranges of the reforming catalyst body 101, the shift reaction catalyst body 104, and the CO selective oxidation catalyst body 106 are TKs (predetermined temperature in a range of 600 to 700° C.), THs (predetermined temperature in a range of 200 to 400° C.), and TJs (predetermined temperature in a range of 100 to 300° C.), the KS profile, the HSG profile, and the JSG profile reach the set values in the reaction temperature ranges of the catalyst bodies 101, 104, and 106 at approximately t1, t2, and t3, respectively. It may be estimated that the time periods that elapse from when the hydrogen generator 118 starts the start-up operation (t0) until t1, t2, and t3 are 20 to 30 minutes, 30 to 40 minutes, and 40 to 50 minutes, respectively.

If water or steam is supplied excessively to the interior of the reformer 100 or the shift converter 103 of the hydrogen generator 118, or otherwise the hydrogen generator 118 is heated and cooled repeatedly due to repeated start-up and stop, then excess steam or excess condensed water may stay in the interior(s) of the shift converter 103 and/or the selective oxidation device 105, causing the shift converter 103 and/or the selective oxidation device 105 to get wet or to contain water droplets.

In such situations, since the rate at which the rising curve of the temperature detected by the shift converter temperature sensor 116 increases and the rate at which the rising curve of the temperature detected by the selective oxidation device sensor 117 increase become low and their rising curves become gentle in contrast to the HSG profile and the JSG profile in the normal state. In FIG. 2, HSN profile represents a characteristic of the detected temperature of the shift converter 103 which increases slowly because of the excess steam or the like and JSN profile represents a characteristic of the detected temperature of the selective oxidation device 106 which increases slowly because of the excess steam or the like.

It has been confirmed that, since the reformer 100 is positioned on upstream side relative to other components in the flow of the material and in the flow of the steam, it is less susceptible to the excess steam or the like, and there is a small difference in increase between the temperature in the normal state which is detected by the reformer temperature sensor 115 and the temperature in the abnormal state which is detected by the reformer temperature sensor 115.

As shown in FIG. 2, each of the set values in the reaction temperature ranges of the shift reaction catalyst body 104 and the CO selective oxidation catalyst body 106 (THs corresponding to the shift reaction catalyst body 104 and TJs corresponding to the CO selective oxidation catalyst body 106) has upper and lower limit values. The upper and lower limit values of the shift reaction catalyst body 104 are respectively represented by THsh and THsl. The upper and lower limit values of the CO selective oxidation catalyst body 106 are respectively represented by TJsh and TJsl. The temperature difference between the set value (THs) in the reaction temperature range of the shift reaction catalyst body 104 and the corresponding upper and lower limit values (THsh and THsl) are respectively represented by ΔTHh and ΔTHl. The temperature difference between the set value (TJs) of the CO selective oxidation catalyst body 106 and the corresponding upper and lower limit values (TJsh and TJsl) are respectively represented by ΔTJh and ΔTJl.

Under the excess steam condition or the like, the HSN profile of the shift converter 103 and/or the JSN profile of the selective oxidation device 105 do not exceed even the lower limit temperature (THsl corresponding to the shift converter 103 and TJsl corresponding to the selective oxidation device 105) during a time period from when the hydrogen generator 118 starts the start-up operation (to) until the time at which the temperature reaches a value between the lower limit value and the upper limit value in the catalyst reaction temperature range (e.g., time t2 and time t3 are illustrated in FIG. 2 as examples of the time) in the normal state (e.g., HSG profile or JSG profile). That is, if the rate at which the detected temperature increases is lower than that in the normal state during a time period from when the hydrogen generator 118 starts the start-up operation until the predetermined time, then, excess water or excess steam may exist in the shift converter 103 or the selective oxidation device 105. The predetermined time is determined based on the reaction temperature ranges of the catalysts. Specifically, the predetermined time may be time at which the temperature profile in the normal state reaches a value between the lower limit value and the upper limit value in the reaction temperature range (here, the upper limit value is used on assumption that the temperature characteristic rises steeply to exceed the reaction temperature range, overshoot, and the reaches the reaction temperature).

Based on the temperature(s) which have been detected by the shift converter temperature sensor 116 that detects the temperature of the shift converter 103 and/or by the selective oxidation device sensor 117 that detects the temperature of the selective oxidation device 105, the controller 205 detects whether or not excess steam or condensed water exists in the interior(s) of the shift converter 103 and/or the selective oxidation device 105, and determines that excess steam or water exists if the detected temperature does not reach the lower limit temperature for the catalytic reaction during a time period from the start-up until the predetermined time as described above. If the detected temperature is above at least the lower limit temperature for the catalytic reaction, the respective catalysts function effectively irrespective of the amount of the steam or water. Therefore, the lower limit temperature for the catalytic reaction is used as a reference to determine whether or not the excess water is allowable.

In other words, based on the rates at which the detected temperatures from the shift converter temperature sensor 116 and the selective oxidation device temperature sensor 117 increase as indicated by arrows in FIG. 2, the controller 205 carries out a determination process below.

If it is determined that the increasing rate (arrow indicated by bold dotted line in FIG. 2) of the temperature detected by the shift converter temperature sensor 116 is less than a predetermined threshold, for example, a lower limit value of the increasing rate (arrow indicated by bold solid line in FIG. 2) of the detected temperature in the normal state, the controller 205 detects and determines that excess water or steam exists in the interior of the hydrogen generator 118 (shift converter 103). If it is determined that the increasing rate (arrow indicated by bold two-dotted line in FIG. 2) of the temperature detected by the selective oxidation device temperature sensor 117 is less than a predetermined threshold, for example, a lower limit value of the increasing rate (arrow indicated by bold dashed line in FIG. 2) of the detected temperature in the normal state, the controller 205 detects and determines that excess water or steam exists in the interior of the hydrogen generator 118 (selective oxidation device 105).

As used herein, the term “increasing rate” of the detected temperature refers to a numeric value that is obtained by dividing the temperature corresponding to the reaction temperature range of each catalyst by the time period required for each catalyst to reach the corresponding reaction temperature range from the start-up, in each temperature curve. For example, as shown in FIG. 2, in the HSG profile of the shift converter 103 in the normal state, the temperature of the shift converter 103 increases to the THs during a time period from t0 until t2, and therefore, the increasing rate of the detected temperature which is output from the shift converter temperature sensor 116 in the normal state is THs/(t2−t0).

While the predetermined threshold is the lower limit value of the increasing rate of the detected temperature of the shift converter 103 in the normal state or the lower limit value of the increasing rate of the detected temperature of the selective oxidation device 105 in the normal state, it is not intended to be limited to these, but may be suitably set depending on the construction or type of the hydrogen generator.

[Operation of Fuel Cell System from Start of Start-up Until Power Generation]

When the steam is supplied suitably in the fuel cell system 300 (under normal state), the detected temperature profiles obtained by the temperature sensors 115, 116, and 117 of the reformer 100, the shift converter 103 and the selective oxidation device 105 represent characteristics that rise in earlier stage to the set values in the reaction temperature ranges of the reforming catalyst body 101, the shift reaction catalyst body 104, and the CO selective oxidation catalyst body 106, as indicated by the KS profile, the HSG profile, and the JSG profile of FIG. 2. In this case, the controller 205 causes the temperatures of the reforming catalyst body 101, the shift reaction catalyst body 104 and the CO selective oxidation catalyst body 106 to reach stable predetermined temperatures, and suitably controls the material feed means 107, the electromagnetic valves 110 and 206, the switching valve 204, the first and second water supply devices 108 and 109, and other components to cause the reformed gas for power generation to be supplied to the anode of the fuel cell 203, and to cause the oxidizing gas to be supplied from the oxidizing gas supply means 202 to the cathode of the fuel cell 203, thus starting a power generation operation.

If the controller 205 determines that excess water or steam exists in the interior of the shift converter 103 or the selective oxidation device 105 (under abnormal state), the detected temperature profiles obtained by the temperature sensors 116 and 117 of the shift converter 103 and the selective oxidation device 105 represent the rising characteristics which are gentle in contract to those in the normal state, as indicated by the HSN profile and the JSN profile in FIG. 2. In this case, the controller 205 reduces the supply amount of the material and the steam to an extent to which carbon deposition does not take place (steam/carbon ratio: S/C=2.0 or more) until the detected temperature of the shift converter 103 exceeds the set value in the reaction temperature range of the shift reaction catalyst body 104 and/or the detected temperature of the selective oxidation device 105 exceeds the set value in the reaction temperature range of the CO selective oxidation catalyst body 106. Since recovery of the components is retarded if the steam is supplied excessively, the upper limit value of the S/C is approximately 5.0, preferably approximately 3.0. Therefore, the controller 205 controls supply of the material and the steam so that S/C is between 2.0 and 5.0, preferably between 2.0 and 3.0 until the detected temperature of the shift converter 103 exceeds the set value in the reaction temperature range of the shift reaction catalyst body 104 and/or the detected temperature of the selective oxidation device 105 exceeds the set value in the reaction temperature range of the CO selective oxidation catalyst body 106.

A specific method of controlling supply of the material and the steam is such that the controller 205 outputs a control signal to the material flow rate control valve built into the material feed means 107 and to the electromagnetic valve 206 that opens and closes the first fuel gas passage 301 to control the flow rate, and outputs a control signal for output control to the flow rate control portions of the first and second water supply portions 108 and 109 to suppress supply of the material and the steam to the reformer 100 to an extent to which deposition of carbon does not take place.

When the HSN profile and/or the JSN profile exceed the set value(s) (THs, TJs) in the reaction temperature range(s) of the shift converter 103 and/or the selective oxidation device 105 (represented by tHn and tJN in FIG. 2), the controller 205 outputs a signal to the control valve in the material feed means 107 and the electromagnetic valve 206 to resets the amount of material to that in the normal state, and outputs a signal to the first and second supply means 108 and 109 to resets the amount of steam to that in the normal state. The controller 205 causes the temperatures of the reforming catalyst body 101, the shift reaction catalyst body 104 and the CO selective oxidation catalyst body 106 to reach the stable predetermined temperatures and correctly controls the material feed means 107, the electromagnetic valves 110 and 216, the switching valve 204, the first and second water supply portions 108 and 109, and other components to supply the reformed gas for power generation to the anode in the interior of the fuel cell 203 and to supply the oxidizing gas from the oxidizing gas supply means 200 to the cathode in the interior of the fuel cell 203, thus starting the power generation operation.

As describe above, in accordance with this embodiment, it is possible to determine whether or not excess water or steam exists in the interior(s) of the shift converter 103 and/or the selective oxidation device 105.

Since it is possible to surely detect the problem associated with the excess steam or the like in the shift converter 103 and/or the selective oxidation device 105, the problem is quickly dealt with, so that the activity of the catalyst(s) of the shift converter 103 and/or the selective oxidation device 105 is quickly restored.

Furthermore, power generation is not carried out with degraded catalytic activity, and catalyst poisoning of the fuel cell 203 which would be caused by carbon monoxide is avoided.

While in this embodiment, the remaining off gas which has not been consumed in the electrode reaction in the fuel cell 203 is caused to flow to the burner of the reformer heater 102 through the passage that is not provided with an auto drain or a condenser that condenses water in the off gas, the technique described in this embodiment is effective to fuel cell systems that are equipped with these components if the total amount of excess steam or condensed water is above the removing abilities of these components.

### Embodiment 2

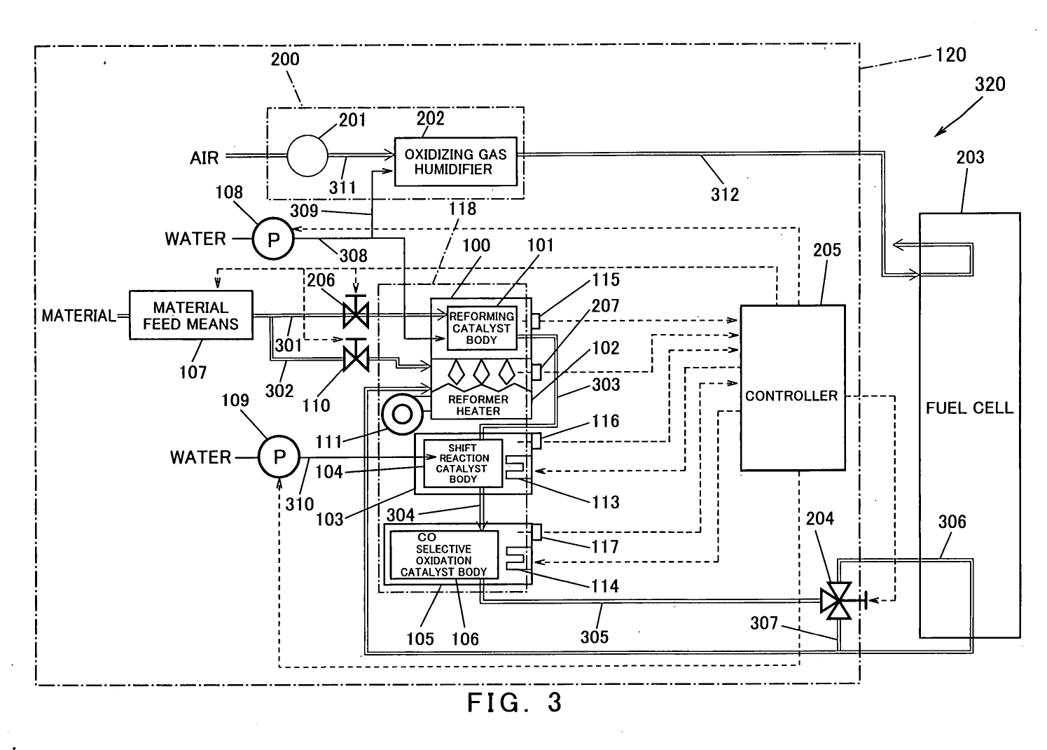

FIG. 3 is a block diagram showing an example of a construction of a fuel cell system according to an embodiment 2 of the present invention.

A construction of a fuel cell system 320 according to this embodiment is identical to that of the fuel cell system 300 of the embodiment 1 except that the reformer heater 102 is equipped with a combustion sensor 207 that detects a combustion state of a combustible gas in the reformer heater 102.

While in the embodiment 1, it is determined whether or not excess water or steam exists in the interior of the hydrogen generator 118 based on the temperatures detected by the shift converter temperature sensor 116 and the selective oxidation device sensor 117, it is determined whether or not excess water or steam exists in the interior of the hydrogen generator 118 based on a signal detected by the combustion sensor 207 in this embodiment.

In FIG. 3, the same reference numerals as those in the embodiment 1 (FIG. 1) denote the same or corresponding components which will not be further described.

The combustion sensor 207 is inserted into the burner of the reformer heater 102 to detect the combustion state of the combustible gas in the reformer heater 102. The combustion sensor 207 is coupled to the controller 205, which receives a signal indicating the combustion state which is output from the combustion sensor 207.

The combustion sensor 207 is configured to convert physical quantity of a flame current or the like which is obtained by using at least one of brightness, temperature (detected by e.g., thermocouple) and rectification (detected by e.g., flame rod) of the flame generated by combustion of the combustible gas in the burner of the reformer heater 102 into an electric signal to detect the combustion state.

Below, an operation for detecting the combustion state of the combustible gas in the burner of the reformer heater 102 by the combustion sensor 207 will be described in detail with reference to the drawings.

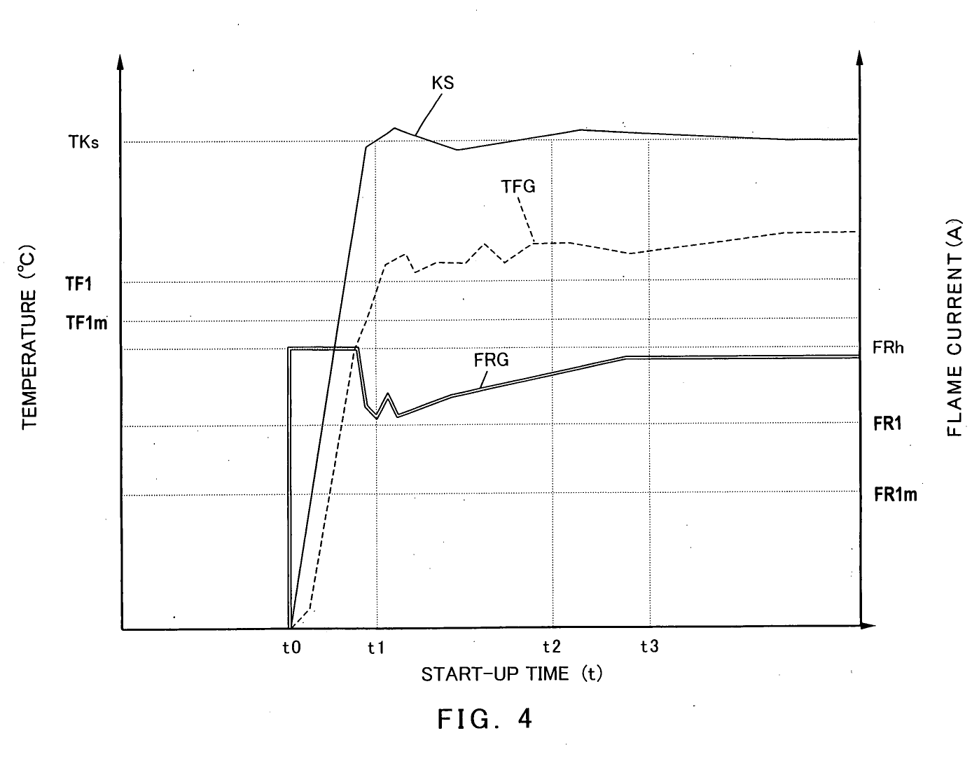

FIG. 4 is a view showing an example of correlation between time (start-up time) on an abscissa axis and a detected reformer temperature (KS), a detected combustion temperature (TFG), and a detected combustion flame current (FRG) on a ordinate axis, in which the time represents a time period that elapses from when the hydrogen generator starts start-up operation (to), the detected reformer temperature (KS) is output from the reformer temperature sensor, the detected combustion temperature (TFG) is output from a temperature detecting means used as the combustion sensor, and the detected combustion flame current (FRG) is output from a flame current detecting means used as the combustion sensor.

FIG. 4 shows the detected combustion temperature (TFG) output from the combustion sensor 207 and the detected combustion flame current (FRG) output from the combustion sensor 207 for a case where the water or the steam is supplied suitably from the first and second water supply means 108 and 109 to the interiors of the reformer 100 and the shift converter 102 of the hydrogen generator 118 and the water or the steam exists in correct amount in the interior of the hydrogen generator 118. As the feed gas, a city gas is used.

The temperature curve of the detected combustion temperature (TFG) indicates a profile similar to that of a temperature curve of the detected reformer temperature (KS), but varies slightly lower than the same over a start-up time period after the reformer heater 102 starts combustion of the combustible gas.

The current curve of the detected combustion flame current (FRG) indicates a profile that rises up more rapidly than that of the temperature curve of the detected reformer temperature (KS) just after the reformer heater 102 starts combustion of the combustible gas (it should be noted that a numeric value of the detected combustion flame current (FRG) is limit-controlled correctly so as not to exceed an upper limit value (FRh) of a flame current during a normal operation). Such a phenomenon may be due to the fact that concentration of ions in the flame that are caused by methane component in the gas that is exhausted from the hydrogen generator 118 and flows to the reformer heater 102 increases rapidly just after the reformer heater 102 starts combustion of the reformer heater 102.

When the temperature of the reforming catalyst body 101 has increased with an elapse of the start-up time, the methane component contained in the feed gas (city gas) is able to be converted into hydrogen through the reforming reaction in the reforming catalyst body 101. After the conversion, the methane concentration in the gas that has been exhausted from the hydrogen generator 118 and flows to the reformer heater 102 decreases, whereas concentration of hydrogen in the gas increases. As a result, ionization in the flame of the reformer heater 102 decreases, causing the detected combustion flame current (FRG) to decrease (near t1). That is, the current curve of the detected combustion flame current (FRG) indicates a profile that gradually decreases near the reforming reaction temperature of the reforming catalyst body 101 without falling below a lower limit value (FRI) of the flame current during the normal operation, and thereafter increases a flame current with an increase in the combustion amount and an increase in the material which are associated with power generation of the fuel cell 203. That is, the flame current decreases according to a conversion near the reforming reaction temperature under a constant material condition, but when the material increases, ionization of the flame per unit volume increases, causing an increase in the flame current flowing in the flame current detecting means.

Subsequently, a temperature curve of the detected combustion temperature (TFG) and a current curve of the detected combustion flame current (FRG) will be described for a case where water is supplied excessively to the interior of the reformer 100 and to the interior of the shift converter 103 of the hydrogen generator 118 and excess steam or excess condensed water stays in the interiors of the reformer 100, the shift converter 103, and the selective oxidation device 105 because of repeated heating and cooling caused by frequent start-up and stop.

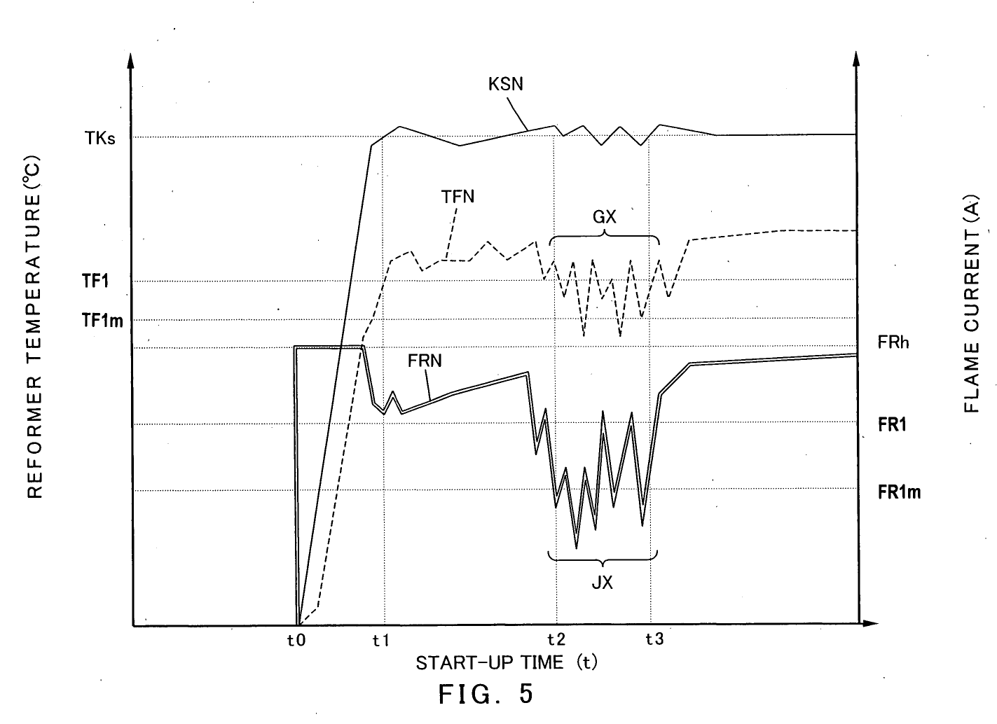

FIG. 5 is a view showing an example of correlation between time (start-up time) on an abscissa axis and a detected reformer temperature (KSN), a detected combustion temperature (TFN), and a detected combustion flame current (FRN) on a ordinate axis, in which the start-up time represents a time period that elapses from when the hydrogen generator starts the start-up operation (to), the detected reformer temperature (KSN) is output from the reformer temperature sensor, the detected combustion temperature (TFN) is output from the temperature sensor used as the combustion sensor, and the detected combustion flame current (FRN) is output from the flame current sensor used as the combustion sensor. FIG. 5 shows the detected combustion temperature (TFN) output from the combustion sensor 207 and the detected combustion flame current (FRN) output from the combustion sensor 207 for a case where the water or the steam is supplied suitably from the first and second water supply means 108 and 109 to the interior of the reformer 100 and to the interior of the shift converter 102 of the hydrogen generator 118 and the water or the steam exists excessively in the interior of the hydrogen generator 118.

Just after the hydrogen generator 118 starts the start-up operation, the gas exhausted from the selective oxidation device 105 is not supplied to the anode of the fuel cell 203, but to the burner in the interior of the reformer heater 102 by the switching operation of the switching valve 204. Just after the hydrogen generator 118 starts the start-up operation, there is a low possibility that excess condensed water staying in the interior of the hydrogen generator 118 is mixed into the exhausted gas in the form of the steam (gas) and is supplied to the burner of the reformer heater 102. For this reason, the temperature curve of the detected reformer temperature (KSN) just after the hydrogen generator 118 starts the start-up operation indicates a profile substantially identical to that of the temperature curve of the detected reformer temperature (KS; see FIG. 4) in the normal state.

With an elapse of the start-up time period of the hydrogen generator 118, the feed gas is heated up to a high temperature by combustion heat from the reformer heater 102. Thereby, the excess water is gradually mixed into the gas in the form of the steam and is supplied to the burner of the reformer heater 102.

To be specific, the excess water is sent to the burner of the reformer heater 102 as the steam during a time period from a time (t1) when the temperature of the shift reaction catalyst body 104 reaches the set value in the reaction temperature range of the shift reaction catalyst body 104 until a time (t2) when the temperature of the CO selective oxidation catalyst body 106 reaches the set value in the reaction temperature range of the CO selective oxidation catalyst body 106. This causes the steam in the burner of the reformer heater 102 to become excess. As a result, the combustion state of the combustible gas in the burner of the reformer heater 102 becomes unstable.

As shown in FIG. 5, the temperature profile of the detected combustion temperature (TFN) output from the combustion sensor 207 indicates a frequent temperature fluctuation (GX) because of the excess steam during a time period from a time (near t2) when the temperature of the shift converter 103 increases to a time (near t3) until the temperature of the selective oxidation device 105 increases.

Likewise, the current profile of the detected combustion flame current (FRN) which is output from the combustion sensor 207 indicates a frequent flame current fluctuation (JX) because of the excess steam during the time period from t2 to t3.

It has been found that, during the temperature fluctuation (GX), the numeric value of the detected combustion temperature (TFN) frequently falls below the lower limit value (TFl) in the normal state which corresponds to a lower limit value in an allowable range of a normal operation of the reformer heater 102 and frequently falls to a lower limit value (TFlm) in an abnormal state which corresponds to a value at which the flame of the burner of the reformer heater 102 vanishes.

Likewise, it has been found that, during the flame current fluctuation (JX), the numeric value of the detected combustion flame current (FRN) frequently falls below the lower limit value (FRl) in the normal state which corresponds to a lower limit value in an allowable range of the normal operation of the reformer heater 102 and frequently falls to a lower limit value (FRlm) in the abnormal state which corresponds to a value at which the flame of the burner of the reformer heater 102 vanishes.

If abnormal states other than supply of the excess steam, such as insufficient supply of the material or the combustion air to the reformer heater 102, takes place, the numeric values of the detected combustion temperature and the detected combustion current do not fall to the value at which the flame of the burner of the reformer heater 102 vanishes so frequently as those associated with the excess steam. From this fact, the inventors or the like considers that it may be determined whether or not the excess steam exists in the interior of the hydrogen generator 118 (shift converter 102 and selective oxidation device 105) based on the numeric value of the detected combustion temperature or the detected combustion current. In view of this, the fuel cell system 320 of this embodiment is configured such that the controller 205 monitors the temperature fluctuation (GX) because of the excess steam at the detected combustion temperature (TFN) and the flame current fluctuation (JX) because of the excess steam at the detected combustion flame current (FRN).

More specifically, if the numeric value of the detected combustion current (TFN) frequently falls below the lower limit value (TFlm) in the abnormal state or the numeric value of the detected fuel flame current (FRN) frequently falls below the lower limit value (FRlm) in the abnormal state during a time period that elapses from the time (near t2) when the temperature of the shift converter 103 increases until the time (near t3) when the temperature of the selective oxidation device 105 increases, the controller 205 determines that the shift converter 103 or the selective oxidation device 105 is wet or contains water droplets.

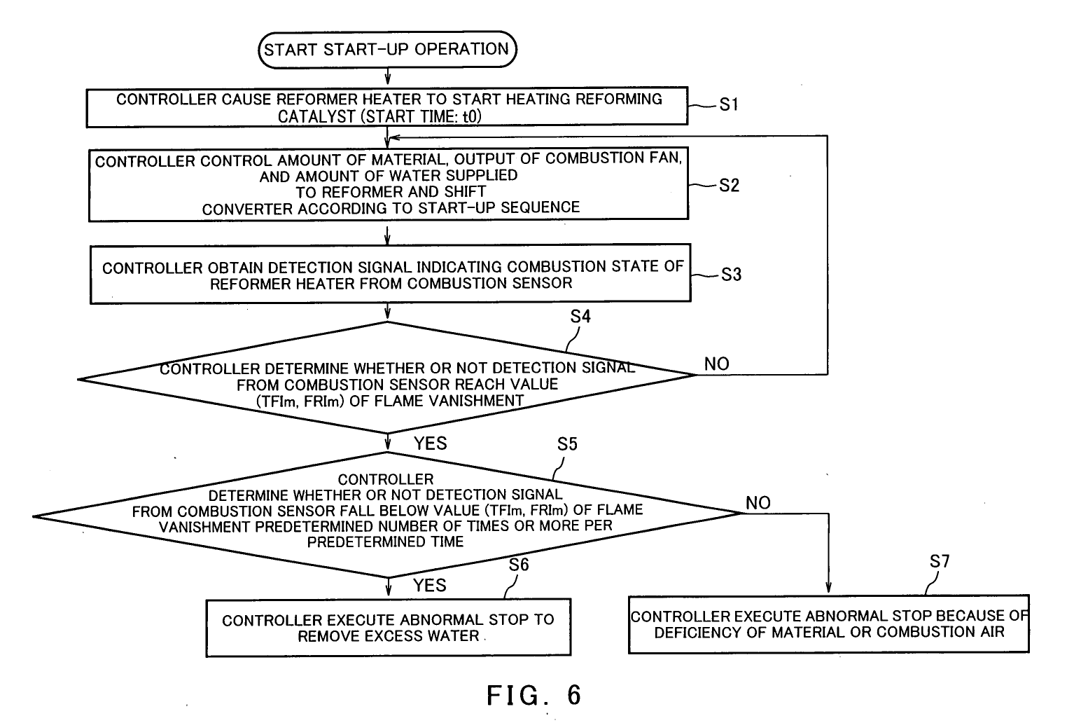

FIG. 6 is a flowchart showing an example of a control program of the controller at start-up of the hydrogen generator. The control program is stored in a storage portion (not shown) of the controller 205.

Upon the start-up operation of the hydrogen generator 118, the reformer heater 102 starts heating the reforming catalyst body 101 (combustion of the combustible gas) (step S1).

The controller 205 controls the amount of material, the output of combustion fan, the amount of reformer water, and the amount of shift converter water to correctly control the hydrogen generator 118 (step S2).

When the controller 205 receives a detection signal indicating a combustion state which is output from the combustion sensor 207 (step S3), it determines whether or not the detection signal becomes the lower limit value (TFlm, FRlm) in the abnormal state which corresponds to the value at which the flame of the burner of the reformer heater 102 vanishes (step S4).

If it is determined that the detection signal from the combustion sensor 207 does not become the lower limit value (TFlm, FRlm) (“No” in step S4), the controller 205 repeats the operation in steps S2 to S4.

On the other hand, if it is determined that the detection signal from the combustion sensor 207 becomes the lower limit value (TFlm, FRlm) (“Yes” in step S4), the controller 205 advances the process to a subsequent determination step. The controller 205 counts the number of times the detection signal from the combustion sensor 207 falls below the lower limit value (TFlm, FRlm), and determines whether or not the count reaches a predetermined number of times or more per predetermined time (step S5).

The detection signal from the combustion sensor 207 frequently falls below the lower limit value (TFlm, FRlm) corresponding to the value at which the flame of the burner of the reformer heater 102 vanishes during the start-up time period of the hydrogen generator 118 in which the temperature fluctuation (GX) or the flame current fluctuation (JX) occurs because of the excess water, i.e., the time period from the time (near t2) when the temperature of the shift converter 103 increases until the time (near t3) when the temperature of the selective oxidation device 105 increases.

If it is determined that the detection signal from the combustion sensor 207 falls below the lower limit value (TFlm, FRlm) the predetermined number of times or more per predetermined time period (predetermined unit time period from t2 to t3) (“Yes” in step S5), the controller 205 determines that excess water exists in the interior of the shift converter 103 or in the interior of the selective oxidation device 105. That is, the controller 205 detects the excess water state. Then, the controller 205 carries out an abnormal stop operation of the hydrogen generator 118 in order to remove excess water from the shift converter 103 or the selective oxidation device 105 (step S6).

If it is determined that the detection signal from the combustion sensor 207 falls below the lower limit value (TFlm, FRlm) the predetermined number of times or more per predetermined time period (“No” in step 5), the controller 205 determines that the material or the combustion air is insufficient in the reformer heater 102, and carries out an abnormal stop operation of the hydrogen generator 118 because of deficiency of the material or the combustion air in the reformer heater 102 (step S7).

In accordance with the determination step of the controller 205, the excess water state, for example, the state in which the shift converter 103 or the selective oxidation device 105 is wet, is correctly determined based on the detection signal from the combustion sensor 207 equipped in the reformer heater 102, separately from the abnormal state such as deficiency of the material in the reformer heater 102.

It may be determined whether or not the flame has vanished because of the excess water state, for example, the state in which the shift converter 103 or the selective oxidation device 105 is wet, based on difference between actual values detected by a feed gas flow sensor, a sensor that detects the number of rotations of the combustion fan, or a combustion air flow sensor, and their target set values.

The controller 205 executes the abnormal stop operation to remove excess water in such a manner that, as described in the embodiment 1, the controller 205 reduces the supply amount of the material and the steam to an extent to which carbon deposition does not take place (steam/carbon ratio: S/C=2.0 or more) until the detected temperature of the shift converter 103 illustrated in FIG. 2 exceeds the set value in the reaction temperature range of the shift reaction catalyst body 104 and/or the detected temperature of the selective oxidation device 105 illustrated in FIG. 2 exceeds the set value in the reaction temperature range of the CO selective oxidation catalyst body 106. This will not be further described.

In the manner described above, in accordance with this embodiment, it is correctly determined whether or not the excess water state occurs in the interior of the shifter 103 or the selective oxidation device 105, for example, the shift converter 103 or the selective oxidation device 105 is wet.

Since the abnormality due to the excess steam or the like in the interior of the shift converter 103 or the selective oxidation device 105 is surely detected, it is dealt with quickly, and thus catalytic activity of the shift converter 103 or the selective oxidation device 103 is quickly restored.

Furthermore, power generation is not carried out with degraded catalytic activity, and catalyst poisoning of the fuel cell 203 which would be caused by carbon monoxide is avoided.

While in this embodiment, the remaining off gas which has not been consumed in the electrode reaction in the fuel cell 203 is caused to flow to the burner of the reformer heater 102 through the passage that is not provided with an auto drain or a condenser that condenses water in the off gas, the technique described in this embodiment is effective to the fuel cell system that is equipped with these components if the total amount of the excess steam or condensed water remaining in the interior of the reformer 100, the shift converter 103, and the selective oxidation device 105 is above the removing ability of these components.

### Embodiment 3

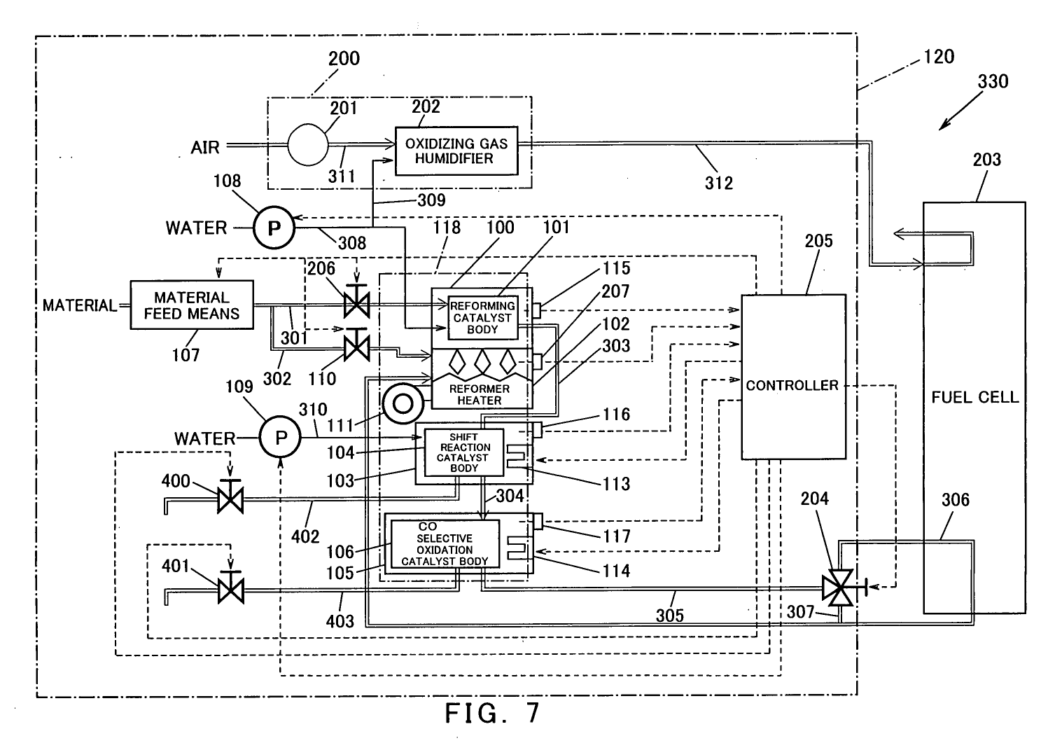

FIG. 7 is a block diagram showing a construction of a fuel cell system according to an embodiment 3 of the present invention. In this embodiment, a modified example 1 for removing excess water from the interior of the shift converter 103 or the selective oxidation device 105 will be described.

Since the constructions and operations of the hydrogen generator 118, the oxidizing gas supply means 200, the fuel cell 203, the controller 205 and other components are identical to those described in the embodiments 1 and 2, they will not be further described.

A fuel cell system 330 of this embodiment differs in construction from the systems of the embodiments 1 and 2 in that the controller 205 controls a shift converter discharge valve 400 coupled to the shift converter 103 so as to discharge excess condensed water remaining in the interior of the shift converter 103 because of the excess steam or the like and a selective oxidation device discharge valve 401 coupled to the selective oxidation device 105 so as to discharge excess condensed water remaining in the interior of the selective oxidation device 105 because of the excess steam or the like. The discharge valves 400 and 401 as discharge means are constructed of electromagnetic valves.

Subsequently, an operation of the fuel cell system 330 of the embodiment 3 will be described.

As in the embodiment 1, if the water for the steam reforming is suitably supplied to the reformer 100 of the hydrogen generator 118 and the water is suitably supplied to the shift converter 103 to stably control the temperature of the shift converter 103, the steam is supplied in correct amount to the interiors of the reformer 100, the shift converter 103, and the selective oxidation device 105. Therefore, the detected temperatures of the reformer 100, the shift converter 103, and the selective oxidation device 105 indicate the profiles represented by KS, HSG, and JSG in FIG. 2. In this case, as in the embodiment 2, the characteristic of the detected reformer temperature (KS) in the normal state, the characteristic of the detected combustion temperature (TFG) in the normal state, and the characteristic of the detected combustion flame current (FRG) in the normal state are obtained as illustrated in FIG. 4.

If the water is supplied excessively to the interior(s) of the reformer 100 and/or the shift converter 103 of the hydrogen generator 118, or excess steam or excess condensed water remains in the interiors of the reformer 100, the shift converter 103 and the selective oxidation device 105 which may be caused by repeated heating or cooling of the hydrogen generator 118 due to frequent start-up and stop of the hydrogen generator 118, the detected temperature of the shift converter 103 and the detected temperature of the selective oxidation device 105 indicate the temperature curves represented by HSN and JSN in FIG. 2. In this case, as in the embodiment 2, the characteristic of the detected reformer temperature (KSN) in the abnormal state, the characteristic of the detected combustion temperature in the abnormal state (TFN), and the characteristic of the detected combustion flame current (FRN) in the abnormal state are obtained as illustrated in FIG. 5.

When the controller 205 determines that excess steam or condensed water exists in the interior(s) of the shift converter 103 and/or the selective oxidation device 105 based on the temperature(s) which have been detected by the shift converter temperature sensor 116 that detects the temperature of the shift converter 103 and/or the selective oxidation device sensor 117 that detects the temperature of the selective oxidation device 105, as in the embodiment 1, it stops the operation of the hydrogen generator 118 and carries out an operation for purging the generated combustible gas.

Or, when the controller 205 determines that excess steam or condensed water exists in the interior of the shift converter 103 or the selective oxidation device 105 based on the detection signal from the combustion sensor 207 by detecting the number of times the detection signal falls below the value at which the flame of the reformer heater 102 vanishes as in the embodiment 2 (see flowchart in FIG. 6), it causes the hydrogen generator 118 to stop operation and carries out the operation for purging the generated combustible gas.

Subsequently, the controller 205 sends control signal to the discharge valves 400 and 401 coupled to the shift converter 103 and the selective oxidation device 105 through discharge passages 402 and 403, respectively to open the discharge valves 400 and 401, during a stop period of the hydrogen generator 118, causing the excess water to be discharged from the shift converter 103 and/or the selective oxidation device 105. The discharge valves 400 and 401 must be opened to enable the excess water to be removed fully for a time period, for example, several hours to one night. It should be understood that, by supplying an inert gas such as nitrogen from an inert gas device (not shown) to the shift converter 103 and/or the selective oxidation device 105, internal pressure(s) of the shift converter 103 and/or the selective oxidation device 105 increase, thus facilitating discharging the excess water and drying the interior(s) of the shift converter 103 and the selective oxidation device 105. As a result, the problem that the interior(s) of the shift converter 103 and/or the selective oxidation device 105 is wet or contains water droplets because of the excess steam is able to be solved earlier.

In accordance with this embodiment, since the abnormality due to the excess steam or the like in the interiors of the shift converter 103 and/or the selective oxidation device 105 is surely detected, it is dealt with quickly, and thus catalytic activity of the shift converter 103 and/or the selective oxidation device 103 is quickly restored.

Furthermore, power generation is not carried out with degraded catalytic activity, and catalyst poisoning of the fuel cell 203 which would be caused by carbon monoxide is avoided. While at least one of the shift converter 103 and the selective oxidation device 105 is purged using the inert gas such as nitrogen when discharging the excess water, the interior of the shift converter 103 or the selective oxidation device 105 may be heated or air may be supplied to the shift converter 103 or the selective oxidation device 105. This is because the internal pressures of the components 103 and 105 increase, enabling the excess water to be easily discharged and the interiors of the shift converter 103 and the selective oxidation device 105 to be dried faster. As a result, the shift converter 103 and the selective oxidation device 105 suitably restore to normal states from the excess water state such as wet state.

### Embodiment 4

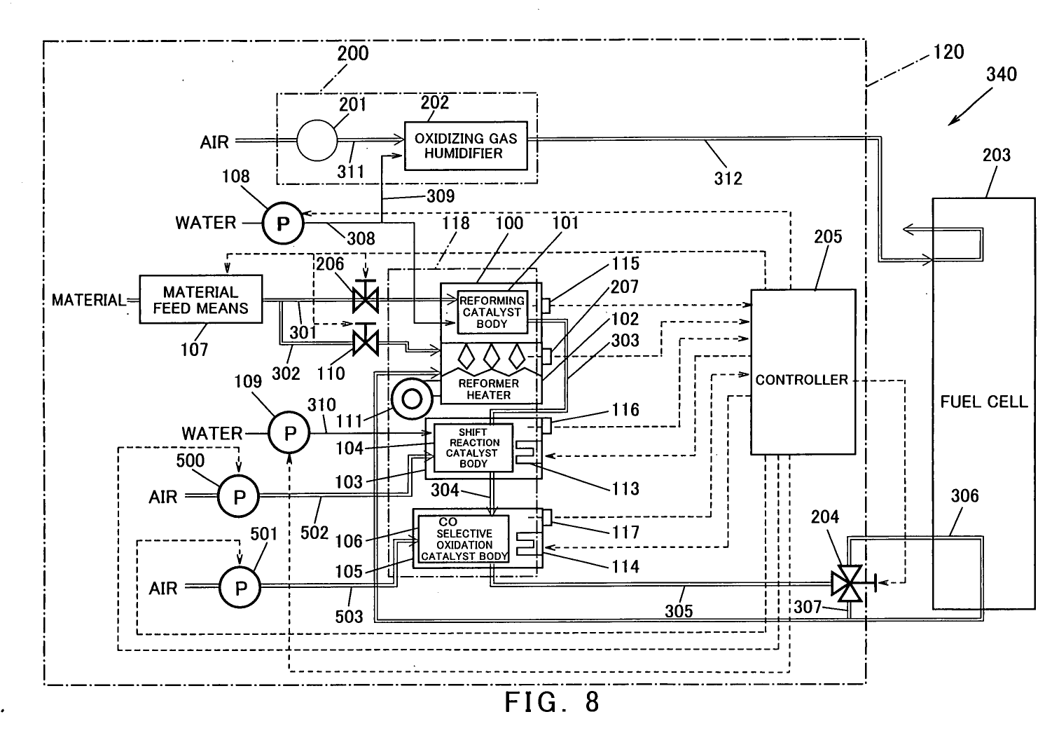

FIG. 8 is a block diagram showing a construction of a fuel cell system according to an embodiment 4 of the present invention. In this embodiment, a modified example 2 for removing excess water from the interior of the shift converter 103 or the selective oxidation device 105 will be described.

Since the constructions and operations of the hydrogen generator 118, the oxidizing gas supply means 200, the fuel cell 203, the controller 205, and other components are identical to those of the embodiments 1 and 2, they will not be further described.

A fuel cell system 340 of this embodiment differs in construction from the systems of the embodiments 1 and 2 in that a shift converter air supply pump 500 which is an air supply device is coupled to the shift converter 103 and is configured to dry and remove excess condensed water remaining in the shift converter 103 because of the excess steam or the like, a selective oxidation device air supply pump 501 which is an air supply device is coupled to the selective oxidation device 105 and is configured to dry and remove excess condensed water remaining in the selective oxidation device 105 because of the excess steam or the like, and the controller 205 controls these air supply pumps 500 and 501.

Subsequently, an operation of the fuel cell system 340 of the embodiment 4 will be described.

As in the embodiment 1, if the water for the steam reforming is suitably supplied to the reformer 100 of the hydrogen generator 118 and the water is suitably supplied to the shift converter 103 to stably control the temperature of the shift converter 103, the steam is supplied in correct amount to the interiors of the reformer 100, the shift converter 103, and the selective oxidation device 105. Therefore, the detected temperatures of the reformer 100, the shift converter 103, and the selective oxidation device 105 indicate the profiles represented by KS, HSG, and JSG in FIG. 2. In this case, as in the embodiment 2, the characteristic of the detected reformer temperature (KS) in the normal state, the characteristic of the detected combustion temperature (TFG) in the normal state, and the characteristic of the detected combustion flame current (FRG) in the normal state are obtained as shown in FIG. 4.

If the water is supplied excessively to the interior(s) of the reformer 100 and/or the shift converter 103 of the hydrogen generator 118, or excess steam or excess condensed water stays in the interiors of the reformer 100, the shift converter 103 and the selective oxidation device 105 which may be caused by repeated heating or cooling of the hydrogen generator 118 due to frequent start-up and stop of the hydrogen generator 118, the detected temperatures of the shift converter 103 and the selective oxidation device 105 indicate the temperature curves represented by HSN and JSN in FIG. 2. In this case, as in the embodiment 2, the characteristic of the detected reformer temperature (KSN) in the abnormal state, the characteristic of the detected combustion temperature in the abnormal state (TFN), and the characteristic of the detected combustion flame current (FRN) in the normal state are obtained as illustrated in FIG. 5.

When the controller 205 determines that excess steam or condensed water exists in the interior(s) of the shift converter 103 and/or the selective oxidation device 105 based on the temperature(s) which have been detected by the shift converter temperature sensor 116 that detects the temperature of the shift converter 103 and/or the selective oxidation device sensor 117 that detects the temperature of the selective oxidation device 105, as in the embodiment 1, it stops the operation of the hydrogen generator 118 and carries out an operation for purging the generated combustible gas.

Or, when the controller 205 determines that excess steam or condensed water exists in the interior of the shift converter 103 or the selective oxidation device 105 based on the detection signal from the combustion sensor 207 by detecting the number of times the detection signal falls below the value at which the flame of the reformer heater 102 vanishes as in the embodiment 2 (see flowchart in FIG. 6), it stops the operation of the hydrogen generator 118 and causes the hydrogen generator 118 to stop operation and carries out the operation for purging the generated combustible gas.

Then, the controller 205 sends control signals to the air supply pumps 500 and 501 to drive these pumps 500 and 501 so that air is supplied from the air supply pumps 500 and 501 to the shift converter 103 and the selective oxidation device 105 through dry air supply passages 502 and 503, respectively during a stop period of the hydrogen generator 118. The air must be supplied to the shift converter 103 and to the selective oxidation device 105 for a time period, for example, several hours to one night to enable the excess water in the interiors to be fully dried. The air is desirably supplied from the air supply pumps 500 and 501 at a flow rate as fast as possible to efficiently dry the water. A flow rate of the air per unit time is required to be at least higher than a flow rate of the normal operation. This makes it possible that the excess water remaining in the shift converter 103 and/or the selective oxidation device 105 is dried and discharged.

In accordance with this embodiment, since the abnormality due to the excess steam or the like in the interior of the shift converter 103 and/or the selective oxidation device 105 is surely detected, it is dealt with quickly, and thus catalytic activity of the shift converter 103 and/or the selective oxidation device 103 is quickly restored.

Furthermore, power generation is not carried out with degraded catalytic activity, and catalyst poisoning of the fuel cell 203 which would be caused by carbon monoxide is avoided.

In this embodiment, since the air is directly applied to the excess water to vaporize water, the catalytic activity is suitably quickly restored.

### Embodiment 5

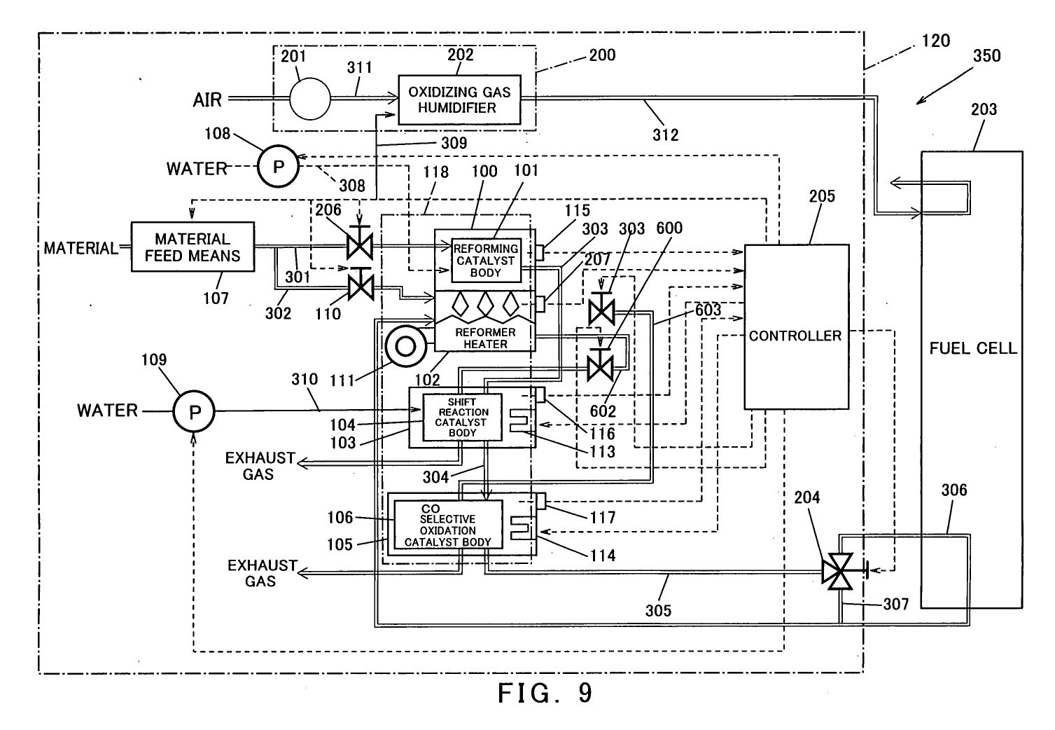

FIG. 9 is a block diagram showing a construction of a fuel cell system according to an embodiment 5 of the present invention. In this embodiment, a modified example 3 for removing excess water from the interior of the shift converter 103 or the selective oxidation device 105 will be described.

Since the constructions and operations of the hydrogen generator 118, the oxidizing gas supply means 200, the fuel cell 203, the controller 205 and other components are identical to those described in the embodiments 1 and 2, they will not be further described.

A fuel cell system 350 of this embodiment differs in construction from the systems of the embodiments 1 and 2 in that a shift converter exhaust gas supply valve 600 that heats and dries the excess condensed water remaining in the shift converter 103 because of the excess steam or the like is provided in a shift converter exhaust gas supply passage 602 coupling the reformer heater 102 to the shift converter 103, a selective oxidation device exhaust gas supply valve 601 that heats and dries the excess condensed water remaining in the selective oxidation device 105 because of the excess steam or the like is provided in a selective oxidation device exhaust gas passage 603 coupling the reformer heater 102 to the selective oxidation device 105, and the controller 205 controls the gas supply valves 600 and 601 provided in the exhaust gas supply passages 602 and 603 as the heating devices.

Subsequently, an operation of the fuel cell system 350 of the embodiment 5 will be described.

As in the embodiment 1, if the water for the steam reforming is suitably supplied to the reformer 100 of the hydrogen generator 118 and the water is suitably supplied to the shift converter 103 to stably control the temperature of the shift converter 103, the steam is supplied in correct amount to the interiors of the reformer 100, the shift converter 103, and the selective oxidation device 105. Therefore, the detected temperatures of the reformer 100, the shift converter 103, and the selective oxidation device 105 indicate the profiles represented by KS, HSG, and JSG in FIG. 2. In this case, as in the embodiment 2, the characteristic of the detected reformer temperature (KS) in the normal state, the characteristic of the detected combustion temperature (TFG) in the normal state, and the characteristic of the detected combustion flame current (FRG) in the normal state are obtained as illustrated in FIG. 4.

If the water is supplied excessively to the interior(s) of the reformer 100 and/or the shift converter 103 of the hydrogen generator 118, or excess steam or excess condensed water remains in the interiors of the reformer 100, the shift converter 103 and the selective oxidation device 105 which may be caused by repeated heating or cooling of the hydrogen generator 118 due to frequent start-up and stop of the hydrogen generator 118, the detected temperatures of the shift converter 103 and the selective oxidation device 105 indicate the temperature curves represented by HSN and JSN in FIG. 2. In this case, as in the embodiment 2, the characteristic of the detected reformer temperature (KSN) in the abnormal state, the characteristic of the detected combustion temperature in the abnormal state (TFN), and the characteristic of the detected combustion flame current (FRN) in the abnormal state are obtained as illustrated in FIG. 5.

When the controller 205 determines that excess steam or condensed water exists in the interior(s) of the shift converter 103 and/or the selective oxidation device 105 based on the temperature(s) which have been detected by the shift converter temperature sensor 116 that detects the temperature of the shift converter 103 and/or the selective oxidation device sensor 117 that detects the temperature of the selective oxidation device 105, as in the embodiment 1, it stops the operation of the hydrogen generator 118 and carries out an operation for purging the generated combustible gas.

Or, when the controller 205 determines that excess steam or condensed water exists in the interior of the shift converter 103 or the selective oxidation device 105 based on the detection signal from the combustion sensor 207 by detecting the number of times the detection signal falls below the value at which the flame of the reformer heater 102 vanishes as in the embodiment 2 (see flowchart in FIG. 6), it causes the hydrogen generator 118 to stop operation and carries out the operation for purging the generated combustible gas.

Then, the controller 205 outputs a signal to the exhaust gas supply valve 600 provided in the exhaust gas supply passage 602 fluidically coupling the reformer heater 102 to the shift converter 103 to open the exhaust gas supply valve 600, during a stop period of the hydrogen generator 118. Likewise, the controller 205 outputs a signal to the exhaust gas supply valve 601 provided in the exhaust gas supply passage 603 fluidically coupling the reformer heater 102 to the selective oxidation device 105 to open the exhaust gas supply valve 601, during a stop period of the hydrogen generator 118. Thereby, the excess water remaining in the shift converter 103 and/or the selective oxidation device 105 is heated and dried efficiently by utilizing residual heat of the exhaust gas resulting from combustion in the reformer heater 102. The shift converter 103 and the selective oxidation device 105 must be heated for a time period, for example, several hours to one night to enable the excess water in the interiors to be fully dried.

While in this embodiment, the exhaust gas supply passages 602 and 603 and the exhaust gas supply valves 600 and 601 used to supply the high-temperature exhaust gas to the shift converter 103 have been described as an example of a heating device, they are merely exemplary, and any other components may be used so long as the excess water remaining in the shift converter 103 or the selective oxidation device 105 is heated and dried.

For example, the shift converter heater 113 and the selective oxidation device heater 114 may be controlled to increase their outputs so that these heaters 113 and 114 serve as heating devices.

While the interior of the shift converter 103 or the selective oxidation device 105 is dried after the operation of the hydrogen generator 118 stops, the shift converter 103 or the selective oxidation device 105 is suitably dried by using the heating devices of this embodiment during an operation of the hydrogen generator 118, without stopping the operation of the hydrogen generator 118.

In accordance with this embodiment, since the abnormality due to the excess steam or the like in the interior of the shift converter 103 or the selective oxidation device 105 is surely detected, it is dealt with quickly, and thus catalytic activity of the shift converter 103 or the selective oxidation device 103 is quickly restored.

Furthermore, power generation is not carried out with degraded catalytic activity, and catalyst poisoning of the fuel cell 203 which would be caused by carbon monoxide is avoided.

### INDUSTRIAL APPLICABILITY

A fuel cell system of this embodiment enables a hydrogen generating apparatus to achieve high performance and is effective as a power generating apparatus for household uses.

1. A hydrogen generating apparatus comprising:
a hydrogen generator including a reformer configured to generate a reformed gas from a material and steam; a shift converter configured to cause the reformed gas supplied from said reformer to be subjected to a shift reaction; and a selective oxidation device configured to decrease a concentration of carbon monoxide in the reformed gas after the shift reaction;
a temperature sensor configured to detect one of a temperature of said shift converter and a temperature of said selective oxidation device; and
a controller configured to determine that excess water or excess steam exists in an interior of said hydrogen generator when an increasing rate of the temperature detected by said temperature sensor is less than a predetermined threshold.

2. The hydrogen generating apparatus according to claim 1, wherein said controller is configured to determine that the excess water or the excess steam exists in an interior of said shift converter when an increasing rate of the temperature of said shift converter that is detected by said temperature sensor is less than a predetermined threshold.

3. The hydrogen generating apparatus according to claim 1, wherein said controller is configured to determine that the excess water or the excess steam exists in an interior of said selective oxidation device when an increasing rate of the temperature of said selective oxidation device that is detected by said temperature sensor is less than a predetermined threshold.

4. A hydrogen generating apparatus comprising:
a hydrogen generator including a reformer configured to generate a reformed gas from a material and steam; a shift converter configured to cause the reformed gas supplied from said reformer to be subjected to a shift reaction; and a selective oxidation device configured to decrease a concentration of carbon monoxide in the reformed gas after the shift reaction to a predetermined concentration or less;
a temperature sensor configured to detect one of a temperature of said shift converter and a temperature of said selective oxidation device; and
a controller configured to perform control to decrease water or steam in an interior of said hydrogen generator when an increasing rate of the temperature detected by said temperature sensor is less than a predetermined threshold.

5. The hydrogen generating apparatus according to claim 4, further comprising:
a water supply device configured to supply the water or the steam to said hydrogen generator,
wherein said controller is configured to control said water supply device to decrease an amount of the water or the steam supplied to the interior of said hydrogen generator when the increasing rate of the temperature detected by said temperature sensor is less than the predetermined threshold.

6. The hydrogen generating apparatus according to claim 4, further comprising:
a water discharge device that is equipped in said shift converter and is configured to discharge the water;
wherein said controller is configured to control said water discharge device to discharge the water from an interior of said shift converter to outside when an increasing rate of the temperature of said shift converter that is detected by said temperature sensor is less than a predetermined threshold.

7. The hydrogen generating apparatus according to claim 4, further comprising:
a water discharge device that is equipped in said selective oxidation device and is configured to discharge the water;
wherein said controller is configured to control said water discharge device to discharge the water from an interior of said selective oxidation device to outside when an increasing rate of the temperature of said selective oxidation device that is detected by said temperature sensor is less than a predetermined threshold.

8. The hydrogen generating apparatus according to claim 4, further comprising:
an air supply device configured to supply air to said shift converter;
wherein said controller is configured to control said air supply device to introduce the air to the interior of said shift converter when an increasing rate of the temperature of said shift converter that is detected by said temperature sensor is less than a predetermined threshold.

9. The hydrogen generating apparatus according to claim 4, further comprising:
an air supply device configured to supply air to said selective oxidation device;
wherein said controller is configured to control said air supply device to introduce the air to an interior of said selective oxidation device when an increasing rate of the temperature of said selective oxidation device that is detected by said temperature sensor is less than a predetermined threshold.

10. The hydrogen generating apparatus according to claim 4, further comprising:
a heating device configured to heat said shift converter;
wherein said controller is configured to control said heating device to heat an interior of said shift converter when an increasing rate of the temperature of said shift converter that is detected by said temperature sensor is less than a predetermined threshold.

11. The hydrogen generating apparatus according to claim 4, further comprising:
a heating device configured to heat said selective oxidation device;
wherein said controller is configured to control said heating device to heat an interior of said selective oxidation device when an increasing rate of the temperature of said selective oxidation device that is detected by said temperature sensor is less than a predetermined threshold.

12. A fuel cell system comprising:
a hydrogen generating apparatus according to claim 1; and
a fuel cell configured to generate electric power using a reformed gas supplied from said hydrogen generating apparatus and an oxidizing gas.

13. A method of operating a hydrogen generating apparatus comprising a hydrogen generator including a reformer configured to generate a reformed gas from a material and steam; a shift converter configured to cause the reformed gas supplied from said reformer to be subjected to a shift reaction; and a selective oxidation device configured to decrease a concentration of carbon monoxide in the reformed gas after the shift reaction; and a temperature sensor configured to detect one of a temperature of said shift converter and a temperature of said selective oxidation device, said method comprising:
decreasing water or steam in an interior of said hydrogen generator
when an increasing rate of the temperature detected by said temperature sensor is less than a predetermined threshold.

14. A method of operating a fuel cell system comprising a hydrogen generator including a reformer configured to generate a reformed gas from a material and steam; a shift converter configured to cause the reformed gas from said reformer to be subjected to a shift reaction; and a selective oxidation device configured to decrease a concentration of carbon monoxide in the reformed gas after the shift reaction to a predetermined concentration or less; a fuel cell configured to generate electric power using the reformed gas supplied from said reformer and an oxidizing gas; and a temperature sensor configured to detect one of a temperature of said shift converter and a temperature of said selective oxidation device, said method comprising:
decreasing water or steam in an interior of said hydrogen generator when an increasing rate of the temperature detected by said temperature sensor is less than a predetermined threshold.

15. A hydrogen generating apparatus comprising:
a hydrogen generator including a reformer configured to generate a reformed gas from a material and steam; a shift converter configured to cause the reformed gas supplied from said reformer to be subjected to a shift reaction; a selective oxidation device configured to decrease a concentration of carbon monoxide in the reformed gas after the shift reaction to a predetermined concentration or less; a reformer heater configured to heat said reformer;
a combustion sensor configured to detect a combustion state of a combustible gas in said reformer heater; and
a controller configured to determine that excess water or steam exists in an interior of said hydrogen generator when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

16. A hydrogen generating apparatus comprising:
a hydrogen generator including a reformer configured to generate a reformed gas from a material and steam; a shift converter configured to cause the reformed gas supplied from said reformer to be subjected to a shift reaction; a selective oxidation device configured to decrease a concentration of carbon monoxide in the reformed gas after the shift reaction to a predetermined concentration or less; a reformer heater configured to heat said reformer;
a combustion sensor configured to detect a combustion state in said reformer heater; and
a controller configured to perform control to decrease water or steam in an interior of said hydrogen generator when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

17. The hydrogen generating apparatus according to claim 16, further comprising:
a water supply device configured to supply the water or the steam to said hydrogen generator,
wherein said controller is configured to control said water supply device to decrease an amount of the water or the steam supplied to the interior of said hydrogen generator when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

18. The hydrogen generating apparatus according to claim 16, further comprising:
a water discharge device that is equipped in said shift converter and/or said selective oxidation device and is configured to discharge water;
wherein said controller is configured to control said water discharge device to discharge water from an interior of said shift converter and/or an interior of said selective oxidation device to outside when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

19. The hydrogen generating apparatus according to claim 16, further comprising:
an air supply device configured to supply air to said shift converter and/or said selective oxidation device;
wherein said controller is configured to control said air supply device to introduce air to an interior of said shift converter and/or an interior of said selective oxidation device when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

20. The hydrogen generating apparatus according to claim 16, further comprising:
a heating device configured to heat said shift converter and/or said selective oxidation device;
said controller is configured to control said heating device to heat an interior of said shift converter and/or said selective oxidation device when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

21. A fuel cell system comprising:
a hydrogen generating apparatus according to claim 15; and
a fuel cell configured to generate electric power using a reformed gas supplied from said hydrogen generator and an oxidizing gas.

22. A method of operating a hydrogen generating apparatus comprising a hydrogen generator including a reformer configured to generate a reformed gas from a material and steam; a shift converter configured to cause the reformed gas supplied from said reformer to be subjected to a shift reaction; a selective oxidation device configured to decrease a concentration of carbon monoxide in the reformed gas after the shift reaction to a predetermined concentration or less; a reformer heater configured to heat said reformer; and a combustion sensor configured to detect a combustion state of a combustible gas in said reformer heater, said method comprising:
decreasing water or steam in an interior of said hydrogen generator when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

23. A method of operating a fuel cell system comprising a hydrogen generator including a reformer configured to generate a reformed gas from a material and steam; a shift converter configured to cause the reformed gas supplied from said reformer to be subjected to a shift reaction; a selective oxidation device configured to decrease a concentration of carbon monoxide in the reformed gas after the shift reaction to a predetermined concentration or less; a reformer heater configured to heat said reformer; a fuel cell configured to generate electric power using a reformed gas supplied from said hydrogen generator and an oxidizing gas; and a combustion sensor configured to detect a combustion state of a combustible gas in said reformer heater, said method comprising:
decreasing water or steam in an interior of said hydrogen generator when a detection signal detected by said combustion sensor reaches, with a frequency of predetermined number of times or more, a numeric value at which a flame vanishes in said reformer heater, during a time period that elapses from when a temperature of said shift converter reaches a shift reaction temperature range until a temperature of said selective oxidation device reaches a selective oxidation reaction temperature range.

24. A fuel cell system comprising:
a hydrogen generating apparatus according to claim 4; and
a fuel cell configured to generate electric power using a reformed gas supplied from said hydrogen generating apparatus and an oxidizing gas.

25. A fuel cell system comprising:
a hydrogen generating apparatus according to claim 16; and
a fuel cell configured to generate electric power using a reformed gas supplied from said hydrogen generator and an oxidizing gas.
